(19) United States
(12) Patent Application Publication
(10) Pub. No.: US 2006/0276144 A1
(43) Pub. Date: Dec. 7, 2006

(54) Modular electrical component system combining power line voltage and low voltage elements

(76) Inventor: Jack Campbell, Hendersonville, TN (US)

Correspondence Address: W. EDWARD RAMAGE, COMMERCE CENTER SUITE 1000, 211 COMMERCE ST, NASHVILLE, TN, 37201, US

(21) Appl. No.: 11/200,928

(22) Filed: Aug. 10, 2005

Related U.S. Application Data
(60) Provisional application No. 60/686,565, filed on Jun. 2, 2005.

(51) Int. Cl. H04B 1/38

(52) U.S. Cl. 455/90.3; 455/402; 375/257

(57) ABSTRACT

An improved system and method of installing wireless network components, such as data transceivers, into residential and commercial buildings and other structures, by combining said wireless network components with standard power receptacles, switches, and similar devices. A module electrical device combines a low-voltage signaling or communications system device with a power line voltage device in a single housing that can be listed and installed in accordance with current electrical codes. The device can be installed in standard power-line level wall box electrical enclosures. The housing provides a plurality of internal cavities through which power line voltage and low-voltage wiring can be routed. A variety of connecting means can be provided on the front and rear faces of the housing. Housing components may be sized and configured to have common physical mating surface designs so as to allow the predictable assembly of power line level components with low-voltage components to complete construction of a single device internally housing both sets of components.

This application claims benefit of and incorporates herein by reference the previously filed Provisional Patent Application No. 60/686,565, filed Jun. 2, 2005, by Jack Campbell, and is entitled to that filing date for priority.

### FIELD OF INVENTION

The present invention relates generally to a system and apparatus for the manufacture, installation and operation of modular electrical components, including components of a wireless local area network (LAN). More particularly, the present invention relates to a system and apparatus for the manufacture, installation and operation of modular electrical components combining power line voltage elements with low-voltage signaling or communications systems elements into standard electrical receptacles, switches, circuit interrupting devices, or other devices used in electrical wiring systems and installed in standard wall receptacle or switch enclosures.

### BACKGROUND OF INVENTION

The use of a variety of low-voltage signaling or communications devices within residential, commercial, or industrial environments has burgeoned in recent years, with a wide array of both wired and wireless audio, video, and data systems being adopted for both functional and entertainment purposes. The ever increasing number of separate products used to facilitate these new systems are mostly standalone devices requiring that exposed power or signal cable be used in order for them to operate. One result of this trend is a growing reality commonly called cable clutter, where masses of wires and cables are frequently tangled behind desks, shelves, and other equipment locations. Another result of this trend is that new structures cannot be affordably prewired to support a large number of these emerging low-voltage signaling or communications systems because of the inherent complexity of having so many different devices to accommodate and install. The growing complexity of installing multiple systems of signaling and communications within a structure is increasing the expense, lowering the customer acceptance, and, generally creating a hurdle in seeing increased adoption of the wiring of these various low-voltage systems into homes and businesses.

An example of such a system are wireless local area networks, use of which has been exploding in recent years. WiFi, a term applied to a group of wireless connection methods based on the IEEE 802.11 standard, has emerged as the preferred method for wireless LANs and setting up Internet “Hot Spots.” WiFi is being built into and sold as an integral feature in several million new notebook computers each month. While wireless networking was a relatively obscure feature for the average consumer only two or three years ago, today WiFi is specifically demanded as part of the minimum feature set by a majority of mobile computer buyers.

The IEEE 802.11 standard currently encompasses three variations on the standard: 802.11a, 802.11b, and 802.11g. All three variations use unlicensed radio spectrum in the 2.4 GHz or 5 GHz bands. The most widely used system is the 802.11b standard, a multichannel implementation within the 2.4 GHz radio band with a maximum data rate of 11 Mb/sec. The 802.11a variant was not finalized until recently, and offers 54 Mb/sec. speeds in the 5 GHz band. This variant has not been successful in gaining widespread adoption. Instead, the 802.11g standard has quickly grown to become the “next level” wireless LAN specification, as it offers the same 54 Mb/sec. speed but within the 2.4 GHz radio band of the popular 802.11b standard, thus maintaining complete compatibility with the slower 802.11b equipment already in wide use. Today's growth WiFi area is with dual-mode 802.11b+g LAN equipment, with the bulk of newer notebook computers being equipped with standard dual-mode b/g wireless LAN cards or internal modules.

One unique feature of 802.11g is its ability to be extended by the use of multiple WiFi transceivers. By including such an extensible architecture (“WDS” or Wireless Distribution System), the working group responsible for the “g” specification has made it theoretically possible to quickly create a very large LAN system in any location. By having one 802.11g access point connected to an network, for instance, and then by pairing that access point with up to six “repeaters” located at various distances and locations around the location of the access point, a very large area can be saturated with 801.11g LAN service, using only one actual wired connection to the network. Areas of buildings larger than 100,000 sq. ft. can be easily and thoroughly saturated with high signal levels, even with a number of intervening walls and interior building blockages. As an example, an entire 3- to 5-floor area of a very large high rise hotel or office building can be served from just one wired network connection, using one 802.11g access point, and four to six 802.11b repeaters. Even more advanced features may be possible with future extensions of the 802.11 standard, such as 802.11n.

Despite the hugely rising popularity of 802.11 based LAN systems, the complexity of enabling and configuring these systems remains a hurdle to gaining complete adoption in many sectors. A wide array of various wireless data transceiver mounting systems have been commercialized. For instance, freestanding enclosures, surface mount wall and ceiling enclosures, proprietary in-wall and in-ceiling enclosures, and, embedded devices for installation into computers have all been commercialized. However, some substantial degree of computer skill is required to connect and use any 802.11 wireless or other wireless LAN equipment. And, with a repeater based network, the complexity increases because of having to use a computer utility to manually configure the connection between each component. Today, a skilled computer network technician must be used to install such systems, and present day methods of installing wireless data networks into residential and commercial buildings have failed to improve the overall simplicity, standardization, and affordability of such systems.

In contrast, the use of standard power receptacles and switches is well known as a standard method for providing power outlets and controls in the walls of residential, commercial, and industrial buildings. Electrical wiring systems in residential, commercial, and industrial environments typically include a plurality of electrical devices interconnected by a plurality of conductors supplying either low voltage or power line voltage from a signal or control source, or from a power disconnect (e.g., a circuit breaker) to the electrical devices. Examples of such electrical devices include receptacles, switches, telephone jacks, data jacks, and television jacks.

Current electrical codes require that certain branch circuits in electrical wiring systems segregate low-voltage and power voltage circuits within the same enclosure, e.g., certain telephone, data, or television circuits, may not be installed into the same enclosure with power line voltage circuits. For example, electrical codes require that certain low-voltage circuits such as data network wiring not be installed into the same enclosure as a 120 VAC wall receptacle. Presently available low-voltage devices are typically separate products from presently available power line voltage devices, thereby facing the requirement of current electrical codes of having the low-voltage and power line voltage devices installed into separate enclosures, or, into barrier-separated compartments within non-standard enclosures.

Many different reasons may arise in which the combination of certain low-voltage devices with certain power line voltage devices may be desired. The obvious reasons are to conserve space, to reduce exposed wiring clutter, and to gain manufacturing efficiencies and lower production costs by consolidating multiple devices into one product housing. Another reason may be to meet the requirements in current electrical codes that a device be listed in order for both power line voltage and low-voltage circuitry be installed within the same enclosure.

Current electrical codes permit the installation of a single listed device into an enclosure, wired according to the manufacturer's installation instructions. Thus, what is needed is a system and apparatus for combining certain low-voltage devices into the same housing as certain power line voltage devices so as to create a single product that can achieve listing status, and that can then be installed in accordance with current electrical codes into standard power line level wall box enclosures.

### SUMMARY OF THE INVENTION

The present invention provides for an improved system and method of installing wireless network components, such as data transceivers, into residential and commercial buildings and other structures, by combining said wireless network components with standard power receptacles and switches. The modular electrical component concept permits the combination of low-voltage signaling or communications system devices and power line voltage devices into a single housing that can be listed and installed in accordance with current electrical codes. The device can be installed in standard power-line level wall box electrical enclosures. The housing provides a plurality of internal cavities through which power line voltage and low-voltage wiring can be routed. Housing components may be sized and configured to have common physical mating surface designs so as to allow the predictable assembly of power line level components with low-voltage components to complete construction of a single device internally housing both sets of components.

In one exemplary embodiment, the device comprises a power receptacle housing containing a standard form factor AC power receptacle and a wireless access point device, such as a wireless data transceiver, with standard attachment means for installing the combined power receptacle and wireless data transceiver into a standard AC wall box enclosure. Both AC power connections and wireless data transmission and reception can be provided within the same device.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### DESCRIPTION OF THE DRAWINGS

FIG. 1 shows a front perspective view of a modular electrical component comprising a wall receptacle power line voltage element and a wireless network access point device element in accordance with one embodiment of the present invention.

FIG. 2 shows a front perspective view of a modular electrical component comprising a wall switch power line voltage element and a cable Internet modem device element in accordance with one embodiment of the present invention.

FIG. 3 shows a rear perspective view of a modular electrical component comprising a wall receptacle power line voltage element and a wireless network access point device element with an RJ45 Ethernet jack connector in accordance with one embodiment of the present invention.

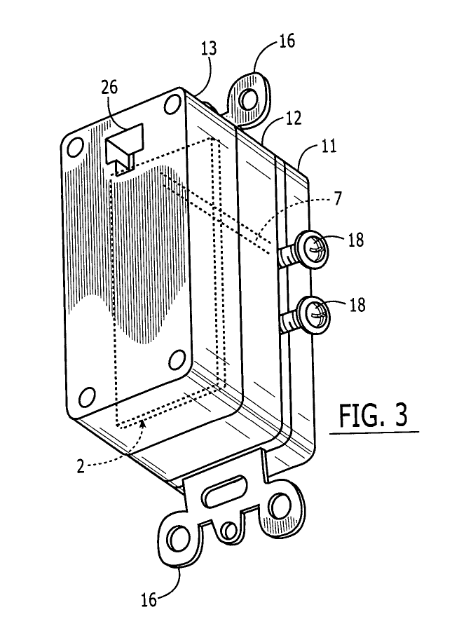

FIG. 4 shows a rear perspective view of a modular electrical component comprising a wall switch power line voltage element and a cable Internet modem device element with an F-Type coaxial cable connector in accordance with one embodiment of the present invention.

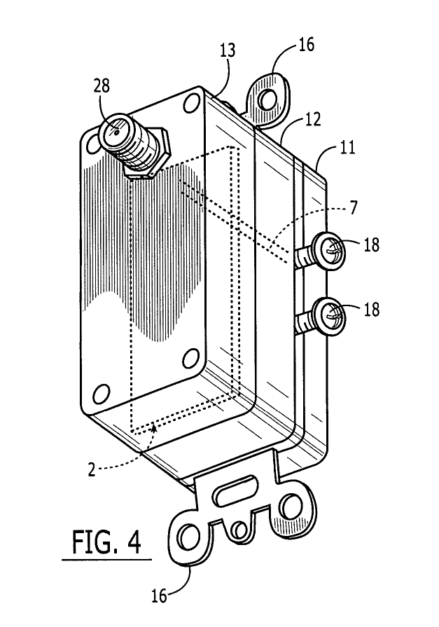

FIG. 5 shows an rear exploded view of a modular electrical component comprising a wall receptacle power line voltage element and a wireless network access point device low-voltage element in accordance with one embodiment of the present invention.

### DETAILED DESCRIPTION OF THE INVENTION

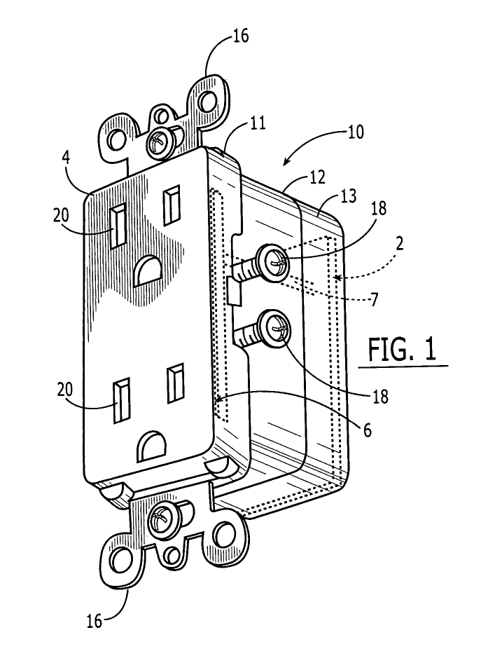

Referring now to the numerous figures, wherein like references identify like elements of the invention, FIG. 1 illustrates a modular electrical component in accordance with one embodiment of the present invention. A low-voltage signaling or communications system device 2 and power line voltage device 4 are located in a single electrical device housing 10. The device includes standard connecting means 18 for connecting the power line voltage device 4 to the electrical power system in the house, building or other structure. The housing 10 may be a single piece, or may comprise two or more components. In one exemplary embodiment, as seen in FIG. 1, the housing 10 comprises a front housing 11, a middle housing 12, and a rear housing 13.

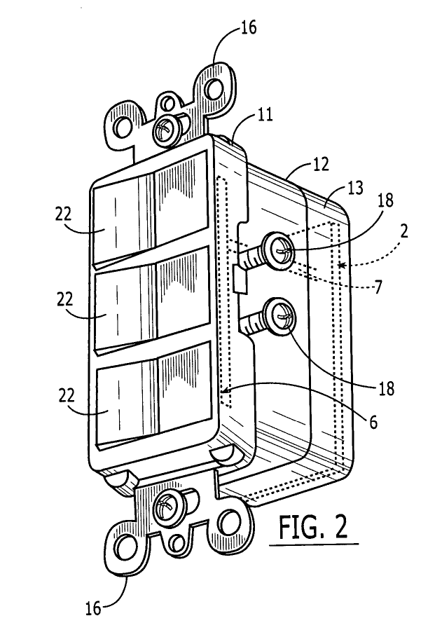

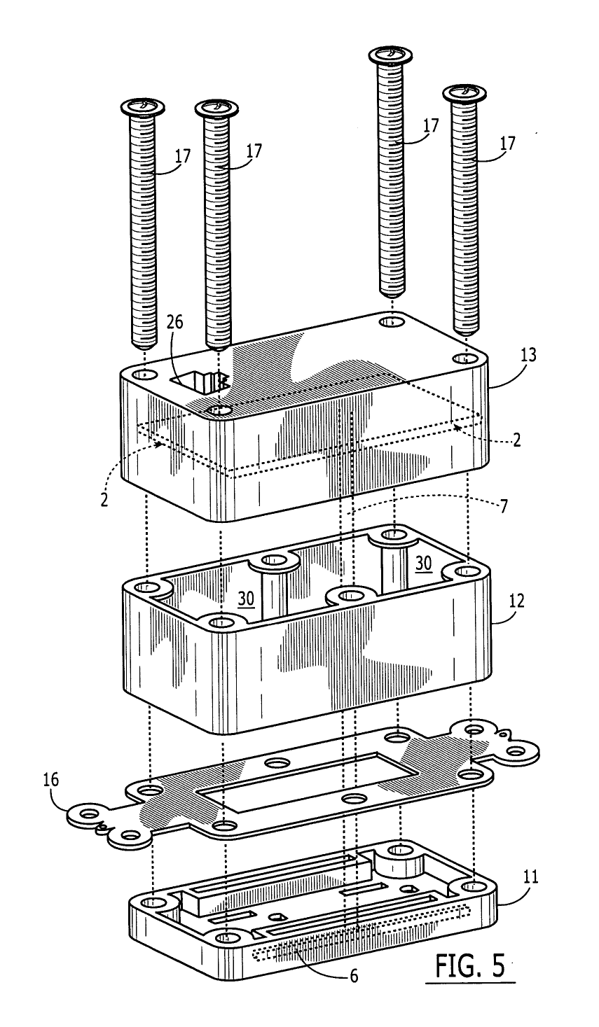

The face of the front housing 11 provides a variety of connectors, outlets, circuit-interrupting device, switches or other components connected to the power line voltage or low-voltage circuits, or both, inside the device, depending on the configuration of the particular device. For example, FIG. 1 shows a pair of standard three-prong electrical power outlets or receptacles 20 on the face of the front housing 11, while FIG. 2 show three rocker switches 22. As seen in FIG. 5, behind the face of the front housing 11 are internal cavities for the internal routing of connecting wires or placement of components required by the modular device's configuration.

The middle housing 12 also may contain internal cavities 30 for the internal routing of connecting wires or placement of components required by the modular device's configuration. The middle housing also may contain attachment means for mechanically internally mounting the power line voltage or low-voltage circuit elements.

The rear housing 13 primarily contains the low-voltage signaling or communications system elements 2, including circuitry, and any rear-facing low-voltage connectors 26. The low voltage elements may be embedded in, or located within cavities in, the rear housing 13. The rear housing's 13 internal cavities may also be used for the internal routing of connecting wires or the placement of components required by the modular device's configuration.

Means 16 for attaching the device to standard wall box electrical enclosures may be attached or to the front 11 or middle 12 housing, depending on the configuration of the device. The attaching means 16 may comprise a pair of opposing mounting brackets, as seen in FIG. 1, that are attached to a wall box with screws or similar means. In an alternative exemplary embodiment, the attachment means 16 may comprise a separate plate fastened between the front 11 and middle 12 housing components, as seen in FIG. 5.

In embodiments where the housing 10 comprises two or more components, the components are assembled and fastened together, permanently or removably, by fastening means. Fastening means can comprise means for snap-fitting the components together, adhesive, and the like. In one exemplary embodiment, as seen in FIG. 5, the fastening means comprises a plurality of screws or bolts 17 that pass through a series of holes in the housing components.

When assembled, the modular component system presents a single device for installation into standard wall box or electrical enclosure of an electrical system. When installed, only standard power line voltage wire connection terminals, switches, or similar devices, and standard low-voltage connectors or jacks, if any, are accessible from the outside front of the device. All power line voltage and low-voltage elements and interconnecting wiring between the power line voltage and low-voltage elements of the assembled device (other than necessary electrical and other connectors or jacks) are fully enclosed within the assembled device so as to be inaccessible from the outside of the assembled device

In various configurations, the power line voltage element 4 may be a power receptacle or outlet 20, one or more switches 22, a circuit interrupting device, or similar device or element used in electrical wiring systems and installed into a standard power line voltage level wall box enclosure. The low-voltage signaling or communications system device 2 may be a wireless network access point device (such as a transceiver), an Internet cable modem device, an ADSL modem device, or other similar devices used in low-voltage signaling or communications systems. In one exemplary embodiment where the power line voltage element is a duplex wall receptacle 20, as seen in FIG. 1, and the low-voltage element is a wireless network access point 2, the front housing 11 may further contain an antenna element 6 within an interior cavity or integrated with the front housing 11, with an antenna connecting means 7, such as a wire, passing from the antenna 6 through the middle housing 12 to the wireless network access point device 2. AC power wiring also would pass through the cavities 30 of the middle housing 12 to the rear housing 13, which contains the AC-to-DC power supply conversion means and other electronic circuitry needed for the low voltage device 2 to function.

In an exemplary embodiment, the modular component system comprises a wall receptacle power line voltage element and a wireless network access point device low-voltage element with the assembled device presenting one or more front-facing AC power outlets or jacks 20 and one or more rear facing RJ-45 network cable jacks 26. One or more front facing RJ-45 network cable jacks 26 may also be added.

In another exemplary embodiment, the modular component system comprises a wall receptacle power line voltage element and an Internet cable modem device low-voltage element with the assembled device presenting one or more front-facing AC power outlets or jacks 20 and one or more rear facing F-Type connectors 28 or RJ-45 network cable jacks 26. One or more front facing F-Type connectors 28 or RJ-45 network cable jacks 26 may also be added.

In another exemplary embodiment, the modular component system comprises a wall receptacle power line voltage element and an ADSL modem device low-voltage element with the assembled device presenting one or more front-facing AC power outlets or jacks 20 and one or more rear facing RJ-11, RJ-14, or RJ-45 network cable jacks 26. one or more front facing RJ-11, RJ-14, or RJ-45 network cable jacks 26 may also be added.

In yet another exemplary embodiment, the modular component system comprises a wall receptacle power line voltage element and a wireless Ultra Wideband bridge device low-voltage element with the assembled device presenting one or more front-facing AC power outlets or jacks 20 and one or more rear facing RJ-45 network cable jacks 26. One or more front facing RJ-45 network cable jacks 26 may also be added.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. An electrical device, comprising:
a device housing with a front face and a back face;
a signaling or communications system device contained in the device housing; and
a power line voltage device contained in the device housing.

2. The electrical device of claim 1, wherein the device housing fits within a standard electrical system wall box.

3. The electrical device of claim 1, wherein the device housing is formed from two or more components.

4. The electrical device of claim 1, wherein the device housing comprises a front housing, a middle housing, and a rear housing.

5. The electrical device of claim 1, wherein the signaling or communications system device is embedded in the back face of the device housing.

6. The electrical device of claim 1, wherein the signaling or communications system device is located inside the housing proximal to the back face.

7. The electrical device of claim 1, wherein the power line voltage device is located inside the housing proximal to the front face.

8. The electrical device of claim 1, further comprising an antenna connected to the signaling or communications system device.

9. The electrical device of claim 8, wherein the antenna is located inside the housing proximal to the front face.

10. The electrical device of claim 1, wherein the power line voltage device is one or more AC power outlets, one or more switches, or a circuit interruption device.

11. The electrical device of claim 1, wherein the signaling or communications system device comprises a wireless network access point device.

12. The electrical device of claim 1, wherein the signaling or communications system device comprises an Internet cable modem device.

13. The electrical device of claim 1, wherein the signaling or communications system device comprises an ADSL modem device.

14. The electrical device of claim 1, wherein the signaling or communications system device comprises a wireless Ultra Wideband bridge device.

15. The electrical device of claim 1, further comprising one or more connection devices on the rear face of the housing.

16. The electrical device of claim 15, wherein the connection device or devices comprise a F-Type connector, RJ-45 network cable jack, RJ-11 network cable jack, or RJ-14 network cable jack.

17. The electrical device of claim 1, further comprising one or more connection devices on the front face of the housing.

18. The electrical device of claim 17, wherein the connection device or devices comprise a F-Type connector, RJ-45 network cable jack, RJ-11 network cable jack, or RJ-14 network cable jack.

19. A modular component system, comprising:
two or more electrical device modules, each electrical device module comprising a device housing with a front face and a back face, a signaling or communications system device contained in the device housing, and a power line voltage device contained in the device housing, wherein each electrical device module is in electronic communication with at least one other electrical device module in the system.

20. The system of claim 19, further wherein the signaling or communications system device in each electrical device module comprises a wireless network access point device, an Internet cable modem device, an ADSL modem device, or a wireless Ultra Wideband bridge device.
